(19) United States
(12) Patent Application Publication
(10) Pub. No.: US 2020/0312286 A1
(43) Pub. Date: Oct. 1, 2020

(54) METHOD FOR MUSIC COMPOSITION EMBODYING A SYSTEM FOR TEACHING THE SAME

(71) Applicant: Vicente Farias, Bronx, NY (US)

(72) Inventor: Vicente Farias, Bronx, NY (US)

(21) Appl. No.: 16/369,153

(22) Filed: Mar. 29, 2019

(51) Int. Cl. G10H 1/00

(52) U.S. Cl. CPC G10H 1/0025; G10H 2210/145; G10H 2210/111

(57) ABSTRACT

A computer-implemented method for music composition embodying a system for teaching the same is provided. Each composition is retrievably stored as music data selectively broken apart into different elemental portions for generating and teaching the composition of hundreds of thousands of additional songs or accompaniments for over 40 musical instruments and all types of human voices. The present invention is adapted to allow the melodies of the additional songs or accompaniments to automatically change the range in order to accommodate the notes range of the selected instrument or human voice.

### BACKGROUND OF THE INVENTION

The present invention relates to method of music composition and, more particularly, to a computer-implemented method for music composition embodying a system for teaching the same, wherein each composition is broken apart into different elemental portions for generating and teaching the composition of additional songs or accompaniments.

Individuals who are novices at music composition still yearn to compose songs or accompaniments. However, lack of expertise in song writing, music theory, chord changes and other elements of crafting a song can be fatal impediments for such individuals' ambitions. Current computer programs adapted to assist in musical composition cannot be used to overcome such impediments. Furthermore, current computer programs have significant limitations that hampers users' development in learning music theory, chord changes, and other song writing skills. Specifically, current computer programs do not give users the ability to compose original songs or accompaniments by just entering a few music patterns, and even though some of today's software may enable users to reuse their original songs, they do not provide the option of creating a database with thousands of versions of the original song with the option of using thousands of different chord changes as harmony. Current computer programs or digital MIDI keyboard do not give users the ability to compose songs or accompaniments for over 40 musical instruments (wind and stringed) and all types of human voices (soprano, alto, tenor, etc.). They do not allow the final melody to automatically change the range in order to accommodate the notes range of the selected instrument or human voice. The lack of all of these components prevents the creation of thousands of versions of a song or accompaniments by manipulating these music patterns, which is a tool for teaching skills in song writing, music theory, chord changes and other aspects of crafting meaningful music.

As can be seen, there is a need for a computer-implemented method for music composition embodying a system for teaching the same, wherein each composition is broken apart into different elemental portions for generating and teaching the composition of additional songs or accompaniments. The present invention goes beyond any human ability and provides users-composers, even if they don't know anything about music theory, the ability to reuse portions of original songs as building blocks to create thousands of additional songs or accompaniments, and learn throughout aid process. The present invention enables users to retrievably store thousands of chord changes in a database to be used for the composition of songs or accompaniments, increasing the possibility of creating a larger number of new songs or accompaniments for over 40 musical instruments and all types of human voices and allowing the final melody to automatically change the range in order to accommodate the notes range of the selected instrument or human voice. Specifically, the present invention embodies many algorithms to reuse music data and compose additional songs or accompaniments through manipulation of earlier song portions and forms embedded in music data—for example, by providing thousands of additional chord changes to be used in compositions, and by providing a database with thousands of ways to structure a song (song form), providing thousands of different ways to change the range of the melodies by section (Intro, Verse, Chorus, Bridge, Ending, etc.) and so forth.

### SUMMARY OF THE INVENTION

In one aspect of the present invention, a computer-implemented method of teaching song composition includes the following: providing one or more input devices operatively associated with a software application for generating music data; coupling a plurality of databases to the software application for retrievably storing said music data, the plurality of databases comprising a group consisting of at least one of a melody database, a melodic rhythm database, a chord change database, and a harmonic rhythm database; and providing a plurality of algorithms for randomly creating melodies and then providing chords to support said melodies from the generated music data retrievably stored in the melody database and the chord change database, respectfully.

In another aspect of the present invention, the computer-implemented method of song composition includes the following: operatively associating one or more input devices configured to generate one or more of a plurality of musical notes with a song composition software application; obtaining a first set of rules that defines two or more of the plurality of musical notes into a music data set comprising at least one of a melody, at least one melodic rhythm, at least one chord change database, and or at least one harmonic rhythm; randomly generating a measured pattern from a combination of a melody music data set and a melodic rhythm music data set; and obtaining a second set of rules that combines a chord change music data set with each measured pattern so as to support one or more melody music data combined thereto, wherein the song composition is configured to output each measured pattern so that a range of one or more of combined melodies of each measured pattern can be selectively changed to accommodate a range of one or more musical instruments or human voice.

In yet another aspect of the present invention, the computer-implemented method of song composition includes the following: operatively associating one or more input devices configured to generate one or more of a plurality of musical notes with a song composition software application; generating two or more of the plurality of musical notes with the one or more input devices; obtaining a first set of rules that defines two or more of the plurality of musical notes into a music data set comprising at least one of a melody, at least one melodic rhythm, at least one chord change database, and or at least one harmonic rhythm; coupling a plurality of databases to the song composition software application for retrievably storing said music data sets; randomly generating a measured pattern from a combination of a melody music data set and a melodic rhythm music data set, wherein each measured pattern is randomly selecting the measured patterns from a group consisting of a one-measured pattern, a two-measured pattern, a three measured pattern, a four measured pattern, or a six measured pattern; obtaining a second set of rules that combines a chord change music data set with each measured pattern so as to support one or more melody music data combined thereto; providing at least one time signature data file obtaining; obtaining a third set of rules that defines each measured pattern as a function of one of the at least one time signature data file; and generating one or more musical scales over each chord change of the second set of rules, wherein the musical scales is randomly selected from a group consisting of a major scale, a pentatonic scale, a mixolydian scale or a blue scale, wherein the song composition is configured to output each measured pattern so that a range of one or more of combined melody music data sets of each measured pattern can be selectively changed to accommodate a range of one or more musical instruments or human voice.

These and other features, aspects and advantages of the present invention will become better understood with reference to the following drawings, description and claims.

### BRIEF DESCRIPTION OF THE DRAWINGS

FIG. 1 is a flow chart of the present invention embodying exemplary embodiments of algorithms 1, 2, 3, 11 and 12;

FIG. 2 is a flow chart of the present invention embodying exemplary embodiments of algorithm 4;

FIG. 3 is a flow chart of the present invention embodying exemplary embodiments of algorithms 5, 6 and 10; and

FIG. 4 is a flow chart of the present invention embodying exemplary embodiments of algorithms 8 and 9.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a computer-implemented method for music composition embodying a system for teaching the same, wherein each composition is broken apart into different elemental portions for generating and teaching the composition of additional songs or accompaniments.

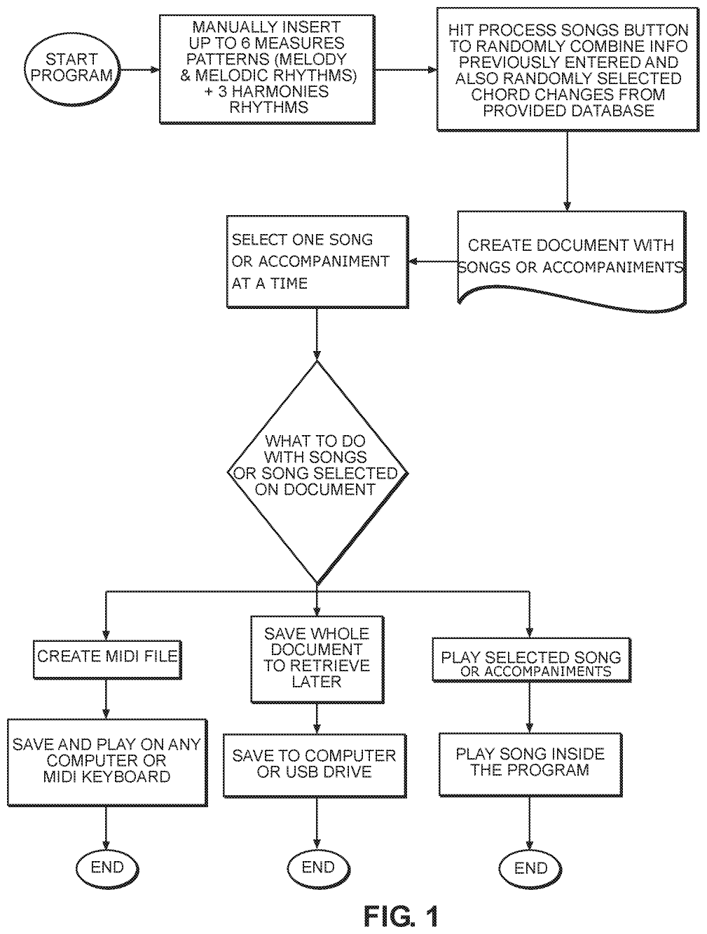

Referring to FIGS. 1 through 4, the present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like. All the algorithms and databases mentioned in this application and on FIGS. 1 through 4 can also be embedded in any digital keyboard with MIDI capabilities.

The present invention is adapted of act as a composer, usually utilizing music theory principles to make songs sound good to the ears. The present invention embodies a plurality of algorithms to put melodic notes close together for easy to sing, and provides chords changes which sound good to the ear. These melodic and harmonic rhythms will also sound good by themselves. After putting all four parts together other algorithms come into operations. There is an algorithm that performs melody resolution automatically based on the melodic rhythm entered. Once the database with additional songs has been completed, the users have the responsibility to go through each song and select the one that sounds best, after selecting the wanted song and the final musical instrument or human voice type, then user can export it to MIDI format. The plurality of algorithms facilitates the composition of music depending on the user-inputted music data (harmonic rhythms, melodic rhythms and melody patterns) to randomly create hundreds of thousands of melodies.

Referring to FIG. 1, a method embodied in the present invention may include the following for composition of songs or accompaniments using piano keyboard—including, but not limited to digital piano keyboard by manufacturers like Yamaha, Roland, Casio, any digital music instrument. first, enter from three to six melodic patterns and from three to six melodic rhythms, three harmonic rhythms and chord changes. This music data is retrievably stored in distinguishable databases. Then the present invention is adapted to break this music data into different parts to be utilized in composing other songs/music data, whereby additional algorithms embodied herein are employed.

Referring to FIG. 1, Algorithm #1—One Measure Patterns: Create 64-One-Measure Patterns retrievably stored in the ‘Motif/Motive’ database is to create additional songs or accompaniments. Algorithm #2—Two Measures Patterns: is adapted to create 32-Two-Measures Patterns retrievably stored in the ‘Motif/Motive’ database to be used to create additional songs or accompaniments. Algorithm #3—Four Measures Patterns: is adapted to create sixteen-Four-Measures Patterns retrievably stored in the ‘Motif/Motive’ database to be used to create additional songs or accompaniments. Algorithm #11—Three Measure Patterns: is adapted to create thousands of songs' versions by combining three measure patterns. Algorithm #12—Six Measure Patterns: is adapted to create hundreds of thousands of songs' versions by combining a six measure patterns.

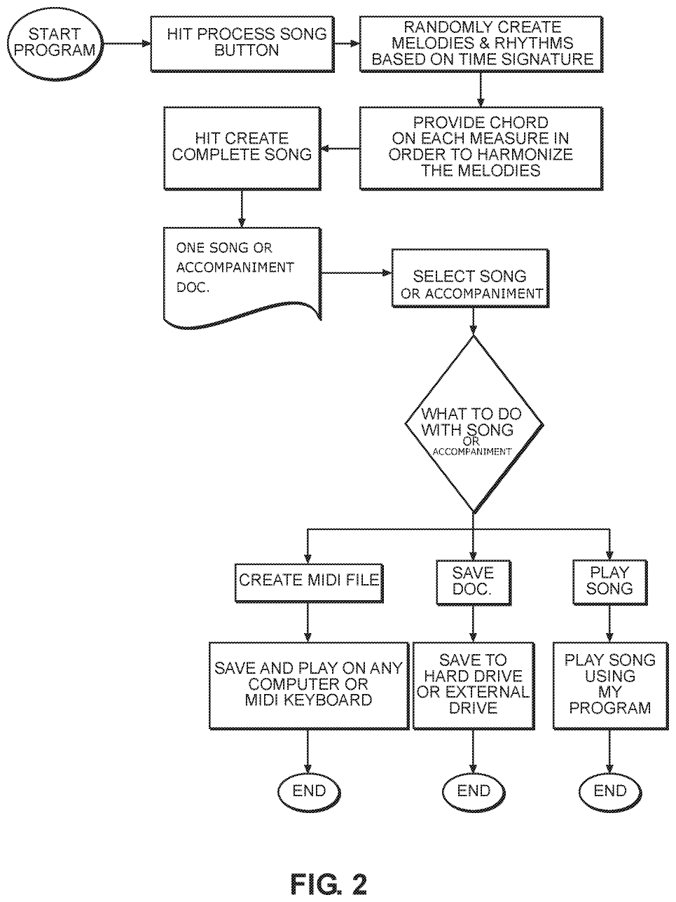

Referring to FIG. 2, Algorithm #4—Auto Harmonizer: is adapted to randomly create melodies and then provide chords to support those melodies. For example, Algorithm #4 may be configured to generate the above-mentioned measured patterns based on selected time signatures.

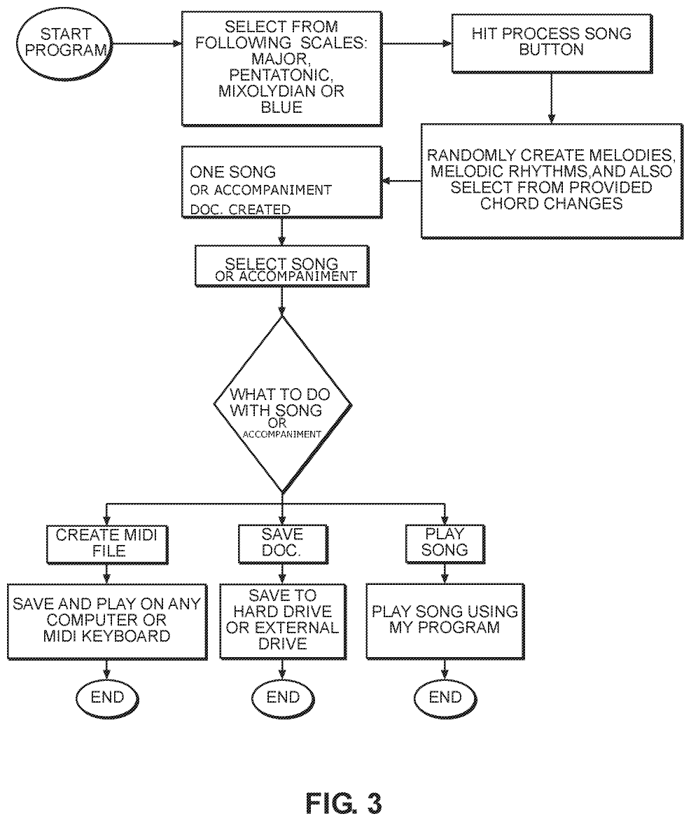

Referring to FIG. 3, Algorithm #5—Auto Scale Improviser Major Scale: is adapted to randomly create major scale melodies over chord changes. Algorithm #6—Auto Improviser Pentatonic Scale: is adapted to randomly create pentatonic scale melodies over chord changes. Algorithm #7—Auto Improviser Mixolydian scale: is adapted to randomly create mixolydian scale over chord changes. Algorithm #10—Auto Improviser Blue Scale: is adapted to randomly create blue scale over chord changes.

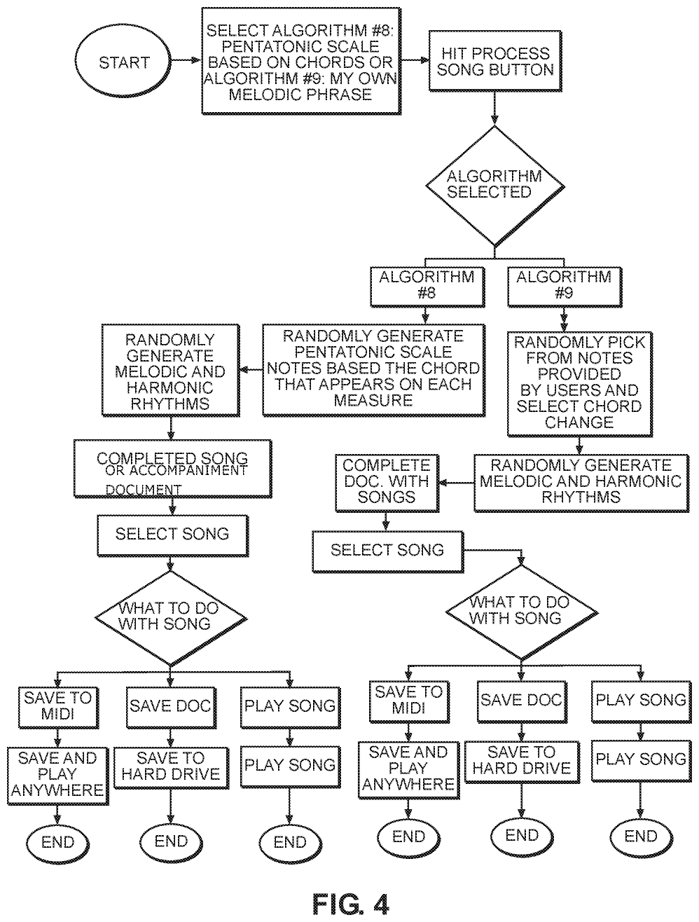

Referring to FIG. 4, Algorithm #8—Auto Improviser Pentatonic Scale Per Measure/Chord: is adapted to randomly create pentatonic scale melodies based on the chord that appears on each measure. Algorithm #9—Auto Improviser My Own Melodic Phrase: is adapted to randomly pick from eight note melodic sequences provided by user, sending random notes/melodies to ‘Melody Database’ for retrievable storage.

The present invention requires a programmer with a deep knowledge of music theory. A method of using the present invention may include the following. The computer implemented method disclosed above may be provided. A user may compose of songs, song portions, or music data can be done by inserting melodies using a computer keyboard, a piano keyboard, or other electronic input devices operatively associated with the software application. Rhythms may be entered using math concepts. Before or after users have finished composing a song (finished songs have five sections for each song (Intro, Verse, Chorus, Bridge and Ending), the user can retrievably store each song or song portion as music data. The present invention provides algorithms for breaking each song, song portion, or music data into four different parts (Melody, Melodic Rhythms, Chord Change, and Harmonic Rhythms). Each one may be created in a separate database. User can run other algorithms to randomly pick Melody, Melodic Rhythm, Chord Changes, Harmonic Rhythms sequences and arrange them in different order, thus creating thousands of additional songs or accompaniments. Once the database with additional songs or accompaniments has been completed, the users have the responsibility to go through each song or accompaniments and select the one that sounds best, after selecting the wanted song or accompaniments along with the final instrument and human voice type, then user can export it to MIDI format. Additionally, the present invention can be used as a teaching song composition tool.

The computer-based data processing system and method described above is for purposes of example only, and may be implemented in any type of computer system or programming or processing environment, or in a computer program, alone or in conjunction with hardware or embedded on any digital keyboard with MIDI capabilities. The present invention may also be implemented in software stored on a computer-readable medium and executed as a computer program on a general purpose or special purpose computer as well as on any digital keyboard with MIDI capabilities. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

1. A computer-implemented method of teaching song composition, comprising:
operatively associating one or more input devices configured to generate one or more of a plurality of musical notes with a song composition software application;
obtaining a first set of rules that defines two or more of the plurality of musical notes into a music data set comprising at least one of a melody data set, at least one melodic rhythm data set, at least one chord change data set, and or at least one harmonic rhythm data set;
randomly generating a measured pattern from a combination of the at least one melody music data set and the at least one melodic rhythm music data set; and
obtaining a second set of rules that combines the at least one chord change music data set with each measured pattern so as to support one or more melody music data sets combined thereto,
wherein the song composition is configured to output each measured pattern so that a range of the one or more of melody music data sets of each measured pattern can be selectively changed to accommodate a range of one or more musical instruments or human voice.

2. The method of claim 1, further comprising generating two or more of the plurality of musical notes with the one or more input devices.

3. The method of claim 1, further comprising coupling a plurality of databases to the song composition software application for retrievably storing said data sets.

4. The method of claim 1, further comprising providing a time signature data file obtaining; and obtaining a third set of rules that defines each measured pattern as a function of said time signature data file.

5. The method of claim 1, further comprising generating one or more musical scales over each chord change music data set of the second set of rules, wherein musical scale is randomly selected from a group consisting of a major scale, a pentatonic scale, a mixolydian scale or a blue scale.

6. The method of claim 5, wherein the pentatonic scale is selected and the song composition software application is configured to randomly create pentatonic scale melodies based on the at least one chord change music data set for each measured pattern.

7. The method of claim 1, randomly selecting the measured patterns from a group consisting of a one-measured pattern, a two-measured pattern, a three measured pattern, a four measured pattern, or a six measured pattern.

8. A computer-implemented method of teaching song composition, comprising:
operatively associating one or more input devices configured to generate one or more of a plurality of musical notes with a song composition software application;
generating two or more of the plurality of musical notes with the one or more input devices;
obtaining a first set of rules that defines two or more of the plurality of musical notes into a music data set comprising at least one of a melody, at least one melodic rhythm data set, at least one chord change data set, and or at least one harmonic rhythm data set;
coupling a plurality of databases to the song composition software application for retrievably storing said data sets;
randomly generating a measured pattern from a combination of the at least one melody music data set and the at least one melodic rhythm music data set, wherein each measured pattern is randomly selecting the measured patterns from a group consisting of a one-measured pattern, a two-measured pattern, a three measured pattern, a four measured pattern, or a six measured pattern;
obtaining a second set of rules that combines the at least one chord change music data set with each measured pattern so as to support one or more melody music data sets combined thereto;
providing at least one time signature data file obtaining;
obtaining a third set of rules that defines each measured pattern as a function of one of the at least one time signature data file; and
generating one or more musical scales over each chord change music data set of the second set of rules, wherein each musical scale is randomly selected from a group consisting of a major scale, a pentatonic scale, a mixolydian scale or a blue scale,
wherein the song composition is configured to output each measured pattern so that a range of the one or more of melody music data sets of each measured pattern can be selectively changed to accommodate a range of one or more musical instruments or human voice.
